(19) United States
(12) Patent Application Publication
(10) Pub. No.: US 2024/0121648 A1
(43) Pub. Date: Apr. 11, 2024

(54) CROSS-LINK INTERFERENCE REPORTING WITH MEASUREMENTS FOR MULTIPLE SUBBANDS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Huilin XU, Temecula, CA (US); Kianoush HOSSEINI, San Diego, CA (US); Ahmed Attia ABOTABL, San Diego, CA (US)

(21) Appl. No.: 18/352,095

(22) Filed: Jul. 13, 2023

Related U.S. Application Data
(60) Provisional application No. 63/378,788, filed on Oct. 7, 2022.

(51) Int. Cl. H04W 24/10; H04L 5/00; H04L 5/14

(52) U.S. Cl. CPC H04W 24/10; H04L 5/0048; H04L 5/14

(57) ABSTRACT

Various aspects of the present disclosure generally relate to wireless communication. In some aspects, a first user equipment (UE) may receive, from one or more of a network node or a second UE, a reference signal in a first subband of a sub-band full-duplex (SBFD) slot. The first UE may transmit, to the network node, a cross-link interference (CLI) report that indicates: a first CLI measurement associated with the reference signal in the first subband of the SBFD slot, and a second CLI measurement associated with a second subband of the SBFD slot. Numerous other aspects are described.

### CROSS-REFERENCE TO RELATED APPLICATION

This patent application claims priority to U.S. Provisional Patent Application No. 63/378,788, filed on Oct. 7, 2022, entitled “CROSS-LINK INTERFERENCE REPORTING WITH MEASUREMENTS FOR MULTIPLE SUBBANDS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for cross-link interference (CLI) reporting with measurements for multiple subbands.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes one or more memories; and one or more processors coupled to the one or more memories, the one or more processors individually or collectively configured to: receive, from one or more of a network node or a second UE, a reference signal in a first subband of a sub-band full-duplex (SBFD) slot; and transmit, to the network node, a cross-link interference (CLI) report that indicates: a first CLI measurement associated with the reference signal in the first subband of the SBFD slot, and a second CLI measurement associated with a second subband of the SBFD slot.

In some implementations, an apparatus for wireless communication at a network node includes one or more memories; and one or more processors coupled to the one or more memories, the one or more processors individually or collectively configured to: transmit, to a UE, a configuration that indicates a first CLI measurement resource and a second CLI measurement resource; and receive, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot.

In some implementations, a method of wireless communication performed by an apparatus of a first UE includes receiving, from one or more of a network node or a second UE, a reference signal in a first subband of an SBFD slot; and transmitting, to the network node, a CLI report that indicates: a first CLI measurement associated with the reference signal in the first subband of the SBFD slot, and a second CLI measurement associated with a second subband of the SBFD slot.

In some implementations, a method of wireless communication performed by an apparatus of a network node includes transmitting, to a UE, a configuration that indicates a first CLI measurement resource and a second CLI measurement resource; and receiving, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot.

In some implementations, a non-transitory computer-readable medium storing a set of instructions for wireless communication includes one or more instructions that, when executed by one or more processors of a first UE, cause the first UE to: receive, from one or more of a network node or a second UE, a reference signal in a first subband of an SBFD slot; and transmit, to the network node, a CLI report that indicates: a first CLI measurement associated with the reference signal in the first subband of the SBFD slot, and a second CLI measurement associated with a second subband of the SBFD slot.

In some implementations, a non-transitory computer-readable medium storing a set of instructions for wireless communication includes one or more instructions that, when executed by one or more processors of a network node, cause the network node to: transmit, to a UE, a configuration that indicates a first CLI measurement resource and a second CLI measurement resource; and receive, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot.

In some implementations, a first apparatus for wireless communication includes means for receiving, from one or more of a network node or a second apparatus, a reference signal in a first subband of an SBFD slot; and means for transmitting, to the network node, a CLI report that indicates: a first CLI measurement associated with the reference signal in the first subband of the SBFD slot, and a second CLI measurement associated with a second subband of the SBFD slot.

In some implementations, an apparatus for wireless communication includes means for transmitting, to a UE, a configuration that indicates a first CLI measurement resource and a second CLI measurement resource; and means for receiving, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex (FD) communications, in accordance with the present disclosure.

FIG. 5 is a diagram illustrating examples of FD communications, in accordance with the present disclosure.

FIG. 6 is a diagram illustrating an example of a sub-band full-duplex (SBFD) slot format, in accordance with the present disclosure.

FIG. 7 is a diagram illustrating examples of interference sources for a UE, in accordance with the present disclosure.

FIGS. 8-15 are diagrams illustrating examples associated with cross-link interference (CLI) reporting with measurements for multiple subbands, in accordance with the present disclosure.

FIGS. 16-17 are diagrams illustrating example processes associated with CLI reporting with measurements for multiple subbands, in accordance with the present disclosure.

FIGS. 18-19 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

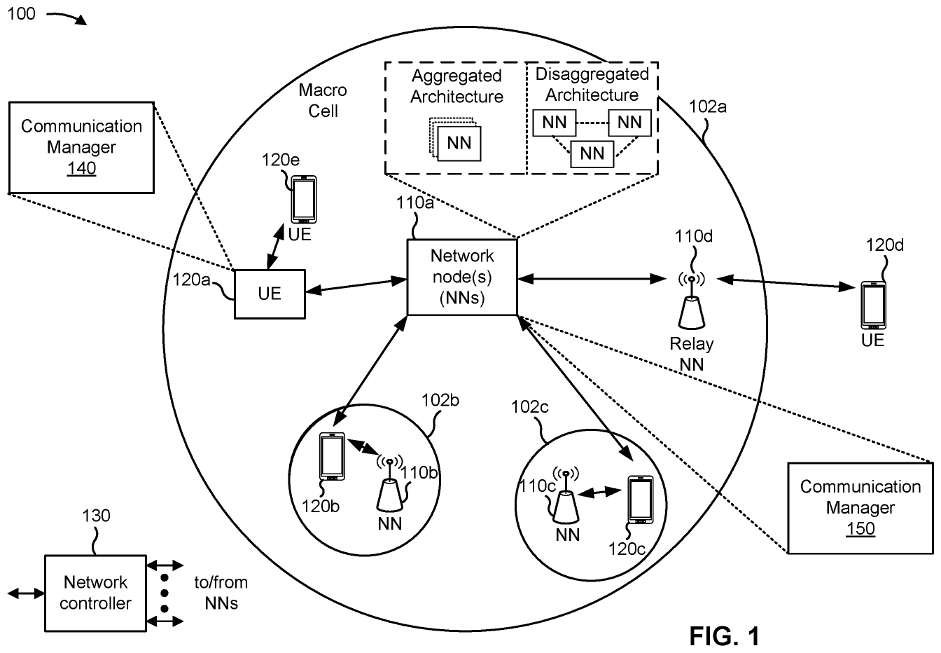

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may receive, from one or more of a network node or a second UE (e.g., UE 120e), a reference signal in a first subband of a sub-band full-duplex (SBFD) slot; and transmit, to the network node, a cross-link interference (CLI) report that indicates: a first CLI measurement associated with the reference signal in the first subband of the SBFD slot, and a second CLI measurement associated with a second subband of the SBFD slot. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a configuration that indicates a first CLI measurement resource and a second CLI measurement resource; and receive, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot. Additionally, or alternatively, the communication manager 150 may perform one or more other operations described herein.

As indicated above, FIG. 1 is provided as an example. Other examples may differ from what is described with regard to FIG. 1.

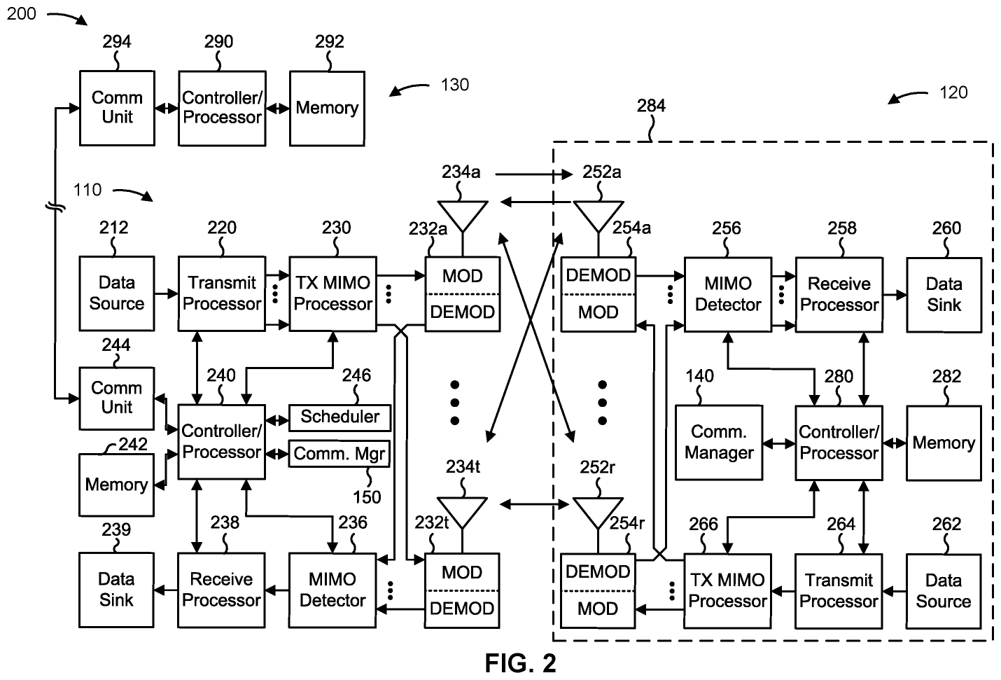

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

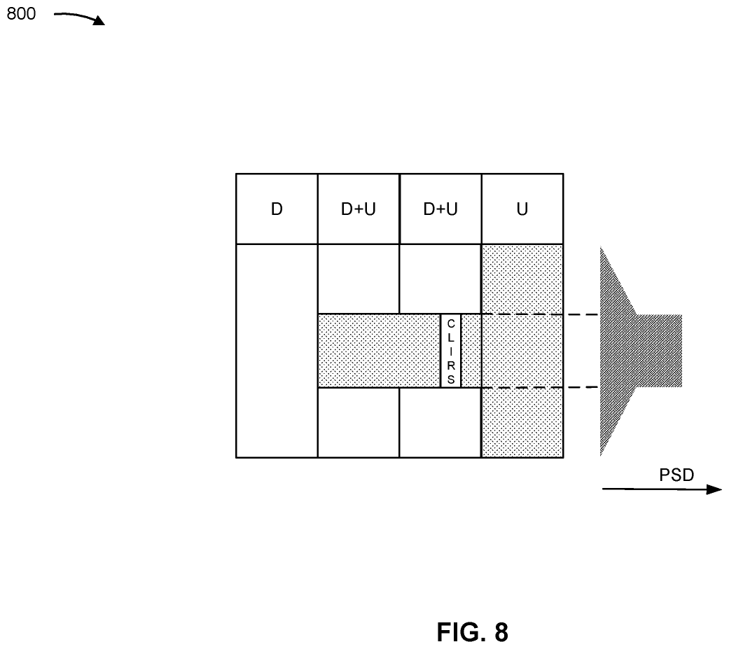

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-19).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-19).

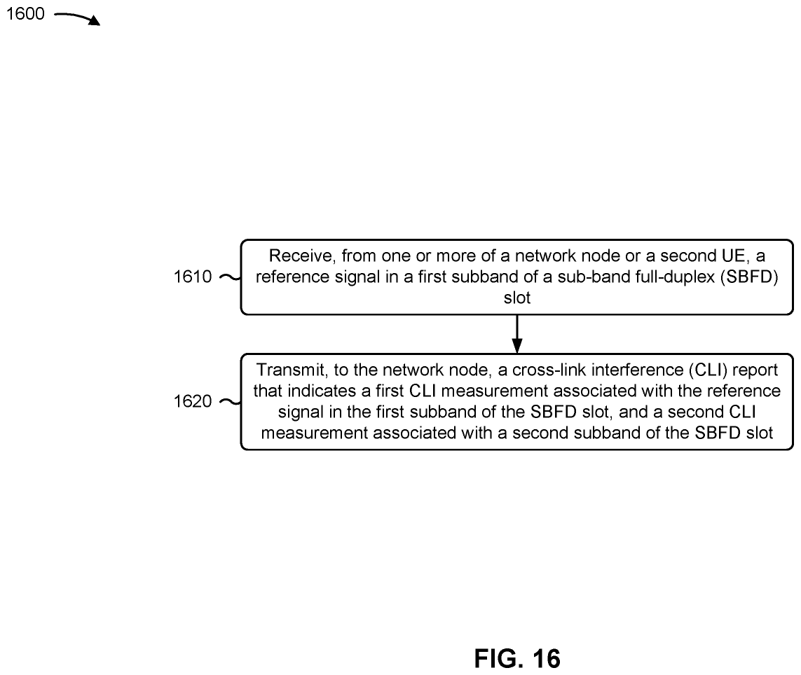

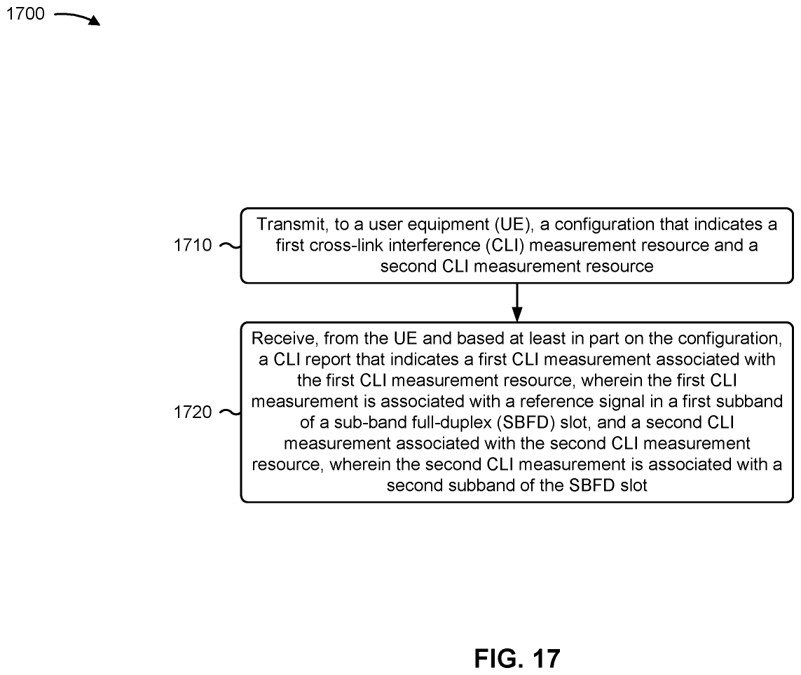

The controller/processor 240 of the network node 110, the controller/processor 280 of the UE 120, and/or any other component(s) of FIG. 2 may perform one or more techniques associated with CLI reporting with measurements for multiple subbands, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving, from one or more of a network node or a second UE (e.g., UE 120e), a reference signal in a first subband of an SBFD slot; and/or means for transmitting, to the network node, a CLI report that indicates: a first CLI measurement associated with the reference signal in the first subband of the SBFD slot, and a second CLI measurement associated with a second subband of the SBFD slot. In some aspects, the means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a configuration that indicates a first CLI measurement resource and a second CLI measurement resource; and/or means for receiving, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

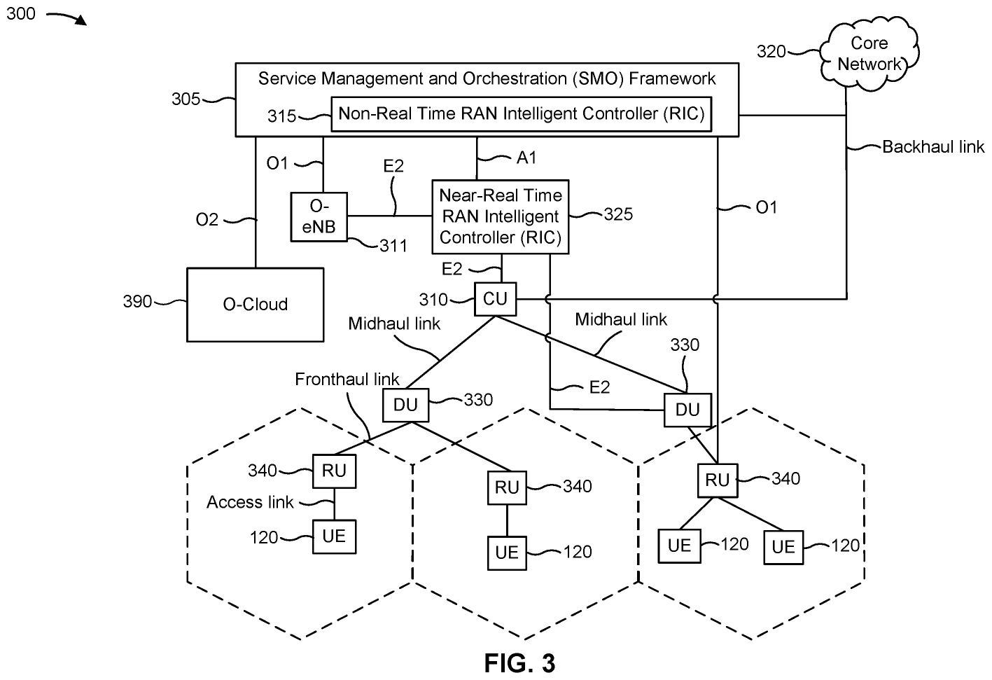

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A full duplex (FD) operation may involve an in-band full-duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a sub-band full duplex (SBFD) operation (or flexible duplex), in which a transmission and a reception may occur at the same time but on a different frequency resource. A downlink resource may be separated from an uplink resource in a frequency domain. In the SBFD operation, no downlink and uplink overlap in frequency may occur.

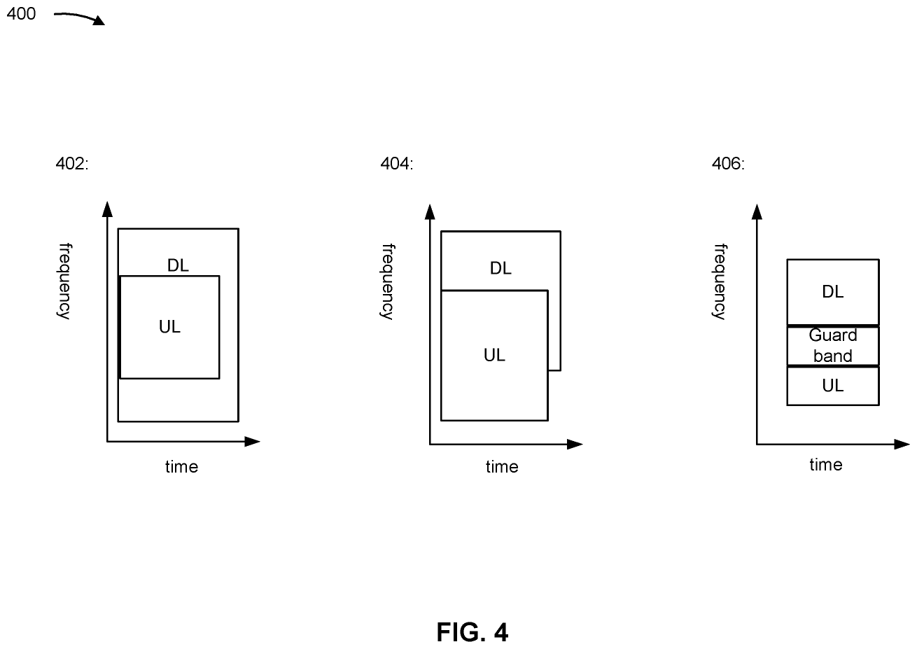

FIG. 4 is a diagram illustrating examples 400 of FD communications, in accordance with the present disclosure.

As shown by reference number 402, a downlink resource and an uplink resource may share the same IBFD time/frequency resource based at least in part on a full overlap. As shown by reference number 404, a downlink resource and an uplink resource may share the same IBFD time/frequency resource based at least in part on a partial overlap. As shown by reference number 406, a downlink resource and an uplink resource may be associated with a same time but different frequency. The downlink resource and the uplink resource may be separated by a guard band.

As indicated above, FIG. 4 is provided as an example. Other examples may differ from what is described with regard to FIG. 4.

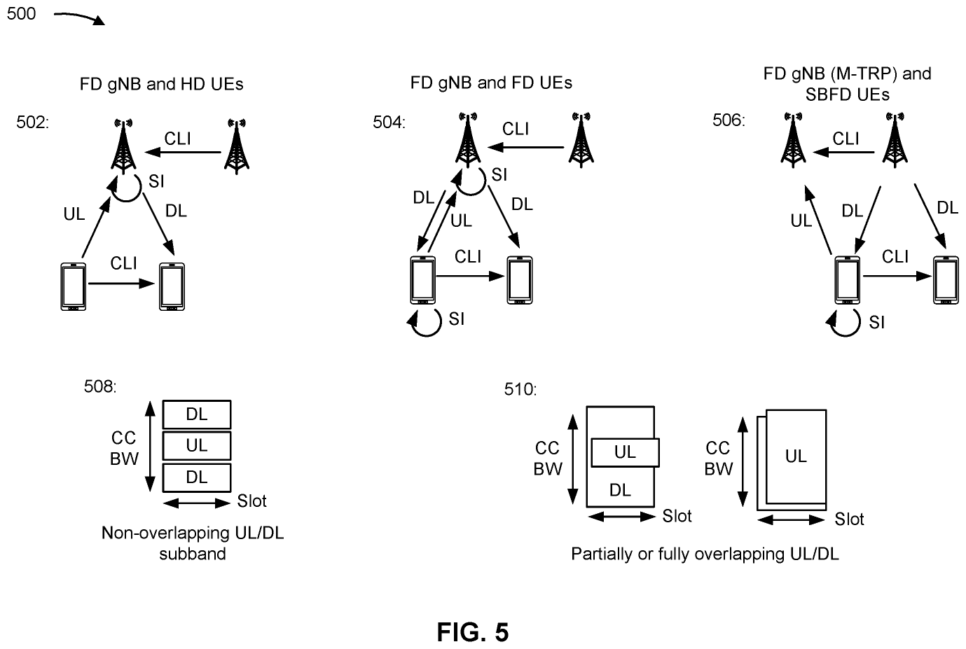

FIG. 5 is a diagram illustrating examples 500 of FD communications, in accordance with the present disclosure.

As shown by reference number 502, an FD network node may communicate with half-duplex UEs. The FD network node may be subjected to cross-link interference (CLI) from another FD network node (e.g., inter-network-node CLI). The FD network node may experience self-interference (SI). The FD network node may receive an uplink transmission from a first HD UE, and the FD network node may transmit a downlink transmission to a second HD UE. The second HD UE may be subjected to CLI from the first HD UE (e.g., inter-UE CLI), where the CLI may be based at least in part on the uplink transmission from the first HD UE.

As shown by reference number 504, an FD network node may communicate with FD UEs. The FD network node may be subjected to CLI from another FD network node. The FD network node may experience SI. The FD network node may transmit a downlink transmission to a first FD UE, and the FD network node may receive an uplink transmission from the first FD UE at the same time as the downlink transmission. The FD network node may transmit a downlink transmission to a second FD UE. The second HD UE may be subjected to CLI from the first HD UE, where the CLI may be based at least in part on the uplink transmission from the first FD UE. The first UE may experience SI.

As shown by reference number 506, a first FD network node, which may be associated with multiple TRPs, may communicate with SBFD UEs. The first FD network node may be subjected to CLI from a second FD network node. The first FD network node may receive an uplink transmission from a first SBFD UE. The second FD network node may transmit downlink transmissions to both the first SBFD UE and a second SBFD UE. The second SBFD UE may be subjected to CLI from the first SBFD UE, where the CLI may be based at least in part on the uplink transmission from the first SBFD UE. The first SBFD UE may experience SI.

As shown by reference number 508, an SBFD slot may be associated with a non-overlapping uplink/downlink sub-band. Within a component carrier bandwidth (CC BW), an uplink (UL) resource may be between, in a frequency domain, a first downlink (DL) resource and a second downlink resource. The first downlink resource, the second downlink resource, and the uplink resource may all be associated with the same slot.

As shown by reference number 510, a slot may be associated with partially or fully overlapping uplink/downlink resources. Within a component carrier bandwidth, an uplink resource may fully or partially overlap with a downlink resource.

As indicated above, FIG. 5 is provided as an example. Other examples may differ from what is described with regard to FIG. 5.

A UE-to-UE co-channel CLI measurement and reporting may be specific to an SBFD mode. The UE-to-UE co-channel CLI measurement and reporting may be specific for a dynamic/flexible time domain duplexing (TDD), and/or common for both the SBFD mode and the dynamic/flexible TDD. The UE-to-UE co-channel CLI measurement and reporting may be associated with a measurement resource/reporting configuration, measurement/reporting information (e.g., including UE processing delay), a relevant information exchange (e.g., between network nodes), and/or a usage of measurements at a network node. Other mechanisms for a network node to network node (e.g., gNB-to-gNB) CLI handling specific for SBFD or a UE-to-UE CLI handling specific for SBFD may be defined.

For inter-UE inter-subband CLI measurement, in a first approach, a victim UE may measure RSSI and/or a signal-to-interference-plus-noise ratio (SINR) within a downlink subband. In a second approach, a victim UE may measure an RSRP of an aggressor UE within an uplink subband. In a third approach, a victim UE may measure an RSSI within an uplink subband. A restriction that CLI is only measured within a downlink bandwidth part (BWP) may not forbid a UE from measuring CLI in an uplink subband when the uplink subband is confined within the downlink BWP.

A UE may be configured to explicitly report CLI measurements, such as CLI-RSRP measurements and/or CLI-RSSI measurements. The UE may report CLI based at least in part on an explicit CLI reporting (e.g., the UE may report explicit CLI measurements, such as the CLI-RSRP measurements and/or CLI-RSSI measurements). In a CLI framework, the UE may perform a layer 3 (L3) CLI reporting based at least in part on a periodic measurement resource. In an adaptive L3 CLI framework, the UE may perform an L3 CLI reporting based at least in part on an adaptive periodic measurement resource. In a layer 2 (L2) CLI framework, the UE may perform an L2 CLI reporting (e.g., via an uplink medium access control control element (MAC-CE)) based at least in part on a semi-persistent or persistent measurement resource. In a layer 1 (L1) CLI framework, the UE may perform an L1 CLI reporting (e.g., via a physical uplink shared channel (PUSCH) or a physical uplink control channel (PUCCH)) based at least in part on an aperiodic, semi-persistent, or periodic measurement resource. As the UE moves between the CLI framework, the adaptive L3 CLI framework, the L2 CLI framework, and the L1 CLI framework, the UE may be provided with an increased configuration flexibility and an adaptation to a dynamic CLI.

An SBFD slot format may be a slot format defines a “downlink and uplink” slot. The “downlink and uplink” slot may be a slot in which a band is used for both uplink and downlink transmissions. The downlink and uplink transmissions may occur in overlapping bands (e.g., IBFD) or in adjacent bands (e.g., SBFD). In a given “downlink and uplink” slot symbol, an HD UE may either transmit in an uplink band or receive in a downlink band. In a given “downlink and uplink” slot symbol, an FD UE may transmit in an uplink band and/or receive in a downlink band (e.g., in the same slot). The “downlink and uplink” slot may include downlink-only symbols, uplink-only symbols, or FD symbols.

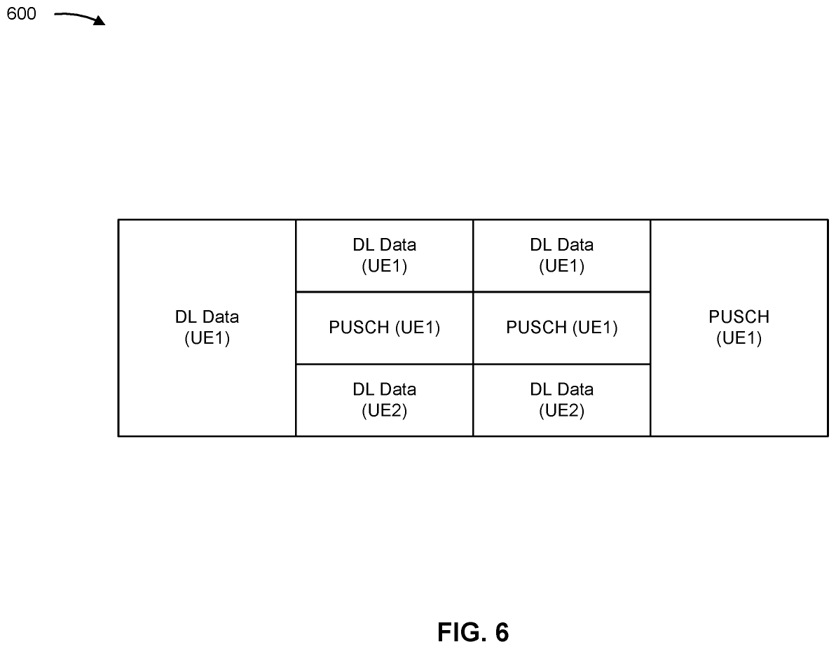

FIG. 6 is a diagram illustrating an example 600 of an SBFD slot format, in accordance with the present disclosure.

As shown in FIG. 6, a first slot may be associated with downlink data for a first UE. A second slot (e.g., an SBFD slot) may be associated with downlink data for the first UE, uplink data for the first UE, and downlink data for a second UE. The uplink data may be associated with a physical uplink shared channel (PUSCH) transmission. A third slot (e.g., an SBFD slot) may be associated with downlink data for the first UE, uplink data for the first UE, and downlink data for the second UE. A fourth slot may be associated with uplink data for the first UE.

As indicated above, FIG. 6 is provided as an example. Other examples may differ from what is described with regard to FIG. 6.

When a UE is operating in an HD mode and a network node is operating in an SBFD/IBFD mode, various sources of interference may be present for the UE. The UE may experience inter-cell interference from other network nodes. The UE may experience intra-cell CLI, which may be interference from UEs in the same cell. The UE may experience inter-cell CLI, which may be interference from UEs in adjacent cells. Further, when the UE is an FD UE, the UE may experience SI (e.g., a downlink transmission of the UE may cause interference to an uplink transmission associated with the UE, or vice versa).

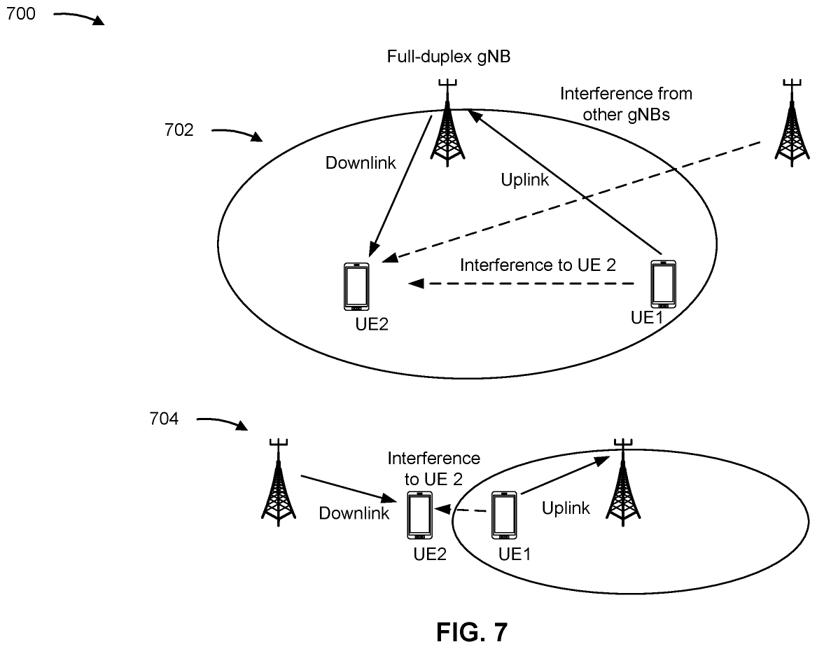

FIG. 7 is a diagram illustrating examples 700 of interference sources for a UE, in accordance with the present disclosure.

As shown by reference number 702, an FD network node may receive an uplink transmission from a first UE, and the FD network node may transmit a downlink transmission to a second UE. The second UE may experience interference from other network nodes, as well as from the first UE. In other words, the first UE may cause interference to the second UE.

As shown by reference number 704, a first network node may receive an uplink transmission from a first UE, and a second network node may transmit a downlink transmission to a second UE. The second UE may experience interference from the first UE. In other words, the first UE may cause interference to the second UE.

As indicated above, FIG. 7 is provided as an example. Other examples may differ from what is described with regard to FIG. 7.

Intra-cell CLI may occur in an SBFD/IBFD mode. In the SBFD mode, a network node may configure a downlink transmission to a second UE in frequency domain resources that are adjacent to frequency domain resources configured for an uplink transmission of a first UE. For example, in an SBFD scenario and in a certain slot, the first UE may transmit the uplink transmission in a middle of a band, and the second UE may receive the downlink transmission from the network node in the adjacent frequency domain resources. The uplink transmission of the first UE may cause CLI to a downlink reception at the second UE. The CLI may be due to an energy leakage caused by a timing and frequency misalignment between the first UE and the second UE, or the CLI may be due to an automatic gain control (AGC) mismatch when a second UE AGC is driven by a downlink serving cell signal of the second UE but the CLI is strong enough to saturate the second UE AGC.

In some cases, increasing a guard band between a scheduled downlink transmission and an uplink transmission may reduce inter-UE CLI and recover some throughput loss. When the inter-UE CLI exceeds a threshold due to a victim UE and an aggressor UE being relatively close to each other, increasing the guard band may not be helpful. A percentage of achievable throughput compared to a baseline without CLI may be determined for different guard band sizes and for different distances separating the victim UE and the aggressor UE. Increasing the guard band between the scheduled downlink transmission and the uplink transmission may help reduce an impact of inter-UE until a certain point, beyond which a performance may be limited by a quantization noise. When the inter-UE CLI is much larger than a strength of a downlink signal, an AGC may be set based at least in part on the inter-UE CLI, which may lead to a loss of dynamic range of the DL signal. Further, an impact of the quantization noise may increase with a difference in uplink-downlink powers.

FIG. 8 is a diagram illustrating an example 800 of SBFD slots, in accordance with the present disclosure.

As shown in FIG. 8, a first slot may be a downlink slot. A second slot may be an SBFD slot (e.g., a downlink and an uplink slot). A third slot may be an SBFD slot. An uplink subband associated with the third slot may be associated with a CLI reference signal (CLI-RS), which may be a sounding reference signal (SRS). The CLI-RS may be used to measure a CLI. A fourth slot may be an uplink slot. An uplink power associated with the uplink subband may be higher than downlink powers associated with downlink subbands in accordance with a power spectral density (PSD). The uplink power associated with the uplink subband may be higher than downlink powers associated with downlink subbands due to CLI.

As indicated above, FIG. 8 is provided as an example. Other examples may differ from what is described with regard to FIG. 8.

An inter-UE measurement and reporting scheme may be defined for SBFD and dynamic TDD. A CLI component in an uplink subband may impact a dynamic range of an analog-to-digital converter (ADC) at a UE (e.g., a victim UE), and a loss in dynamic range may result in increased quantization noise. In order to accurately characterize an inter-UE CLI, the UE may need to measure and report both a CLI component in the uplink subband and CLI components in downlink subbands. In other words, the UE may need to measure and report CLI levels for the uplink subband and the downlink subbands. However, the UE may not be configured to measure and report multiple CLI components (e.g., CLI for each of the uplink subband and the downlink subbands), and instead may measure and report an overall CLI, which may not as accurately reflect the inter-UE CLI.

In various aspects of techniques and apparatuses described herein, a first UE may receive, from a network node, a configuration that indicates a first CLI measurement resource and a second CLI measurement resource. The first UE may receive, from the network node or a second UE, a reference signal in a first subband of an SBFD slot. The first UE may transmit, to the network node, a CLI report that indicates a first CLI measurement associated with the reference signal in the first subband of the SBFD slot, and a second CLI measurement associated with a second subband of the SBFD slot. The first CLI measurement may be associated with the first CLI measurement resource and the second CLI measurement may be associated with the second CLI measurement resource. The CLI report may be associated with a first CLI component and a second CLI component. The first CLI component may be associated with the first CLI measurement for the first subband. The second CLI component may be associated with the second CLI component for the second subband. The first subband and the second subband may be associated with different types of subbands in the SBFD slot. As a result, the first UE may accurately characterize inter-UE CLI by measuring and reporting both the first CLI component for the first subband and the second CLI component for the second subband in the CLI report, and the network node may be better suited for performing scheduling for the first UE based on the CLI report, thereby improving a performance of the UE.

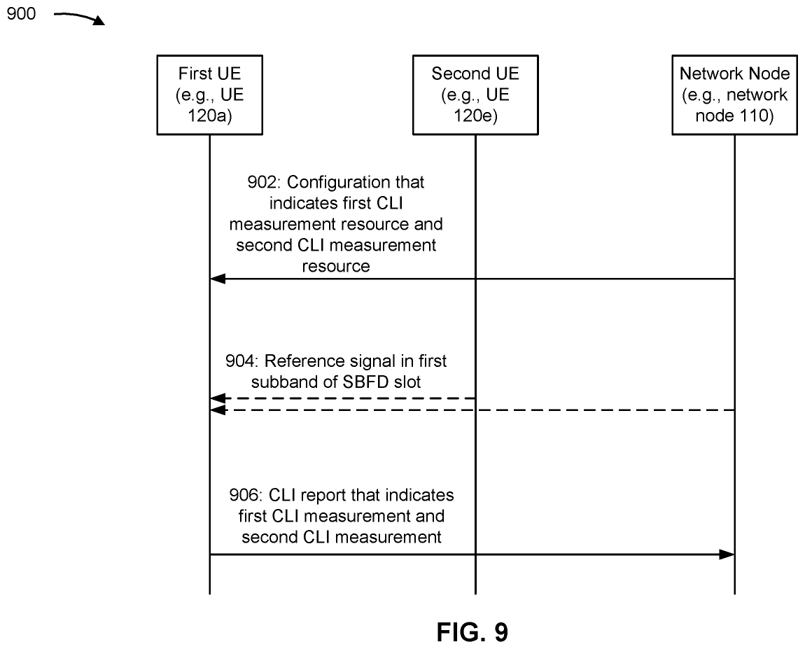

FIG. 9 is a diagram illustrating an example 900 associated with CLI reporting with measurements for multiple subbands, in accordance with the present disclosure. As shown in FIG. 9, example 900 includes communication between a first UE (e.g., UE 120a) and a network node (e.g., network node 110). In some aspects, the first UE and the network node may be included in a wireless network, such as wireless network 100.

In some aspects, the first UE may be a victim UE. A second UE may be an aggressor UE. The second UE may cause CLI for the first UE. For example, an uplink transmission of the second UE may cause CLI to a downlink reception of the first UE.

As shown by reference number 902, the first UE may receive, from the network node, a configuration that indicates a first CLI measurement resource and a second CLI measurement resource. The first CLI measurement resource may be for a first CLI measurement, and the second CLI measurement resource may be for a second CLI measurement. The configuration may be for measuring and reporting CLI components, which may help the first UE to accurately characterize inter-UE CLI.

As shown by reference number 904, the first UE may receive, from the network node and/or the second UE, a reference signal in a first subband of an SBFD slot. The reference signal may be a CLI-RS, such as an RS, which may be received from the second UE. The reference signal may be a channel state information reference signal (CSI-RS), which may be received from the network node.

As shown by reference number 906, the first UE may transmit, to the network node, a CLI report. The CLI report may indicate a first CLI measurement associated with the reference signal in the first subband of the SBFD slot. The CLI report may indicate a second CLI measurement associated with a second subband of the SBFD slot. The CLI report may be associated with a first CLI component and a second CLI component. The first CLI component may be associated with the first CLI measurement for the first subband. The second CLI component may be associated with the second CLI component for the second subband. The first subband and the second subband may be associated with different types of subbands. For example, the first subband may be a downlink subband and the second subband may be an uplink subband, or the first subband may be an uplink subband and the second subband may be a downlink subband.

In some aspects, the reference signal may be the CLI-RS received from the second UE. The CLI-RS may be the SRS. The first subband may be the uplink subband and the second subband may be the downlink subband. The first CLI measurement may be associated with a CLI-RS RSRP in the uplink subband. The second CLI measurement may be associated with a CLI RSSI in the downlink subband.

In some aspects, the reference signal may be the CSI-RS received from the network node. The first subband may be the downlink subband and the second subband may be the uplink subband. The first CLI measurement may be associated with a CSI-RS-SINR in the downlink subband. The second CLI measurement may be associated with a CLI RSSI in the uplink subband.

In some aspects, the first CLI measurement resource may be a CLI RSRP measurement resource that corresponds to the reference signal, where the reference signal may be received from the second UE in the first subband. The reference signal may be the CLI-RS. The first subband may be the uplink subband. The second CLI measurement resource may be a CLI RSSI measurement resource configured in the second subband. The second subband may be the downlink subband. A measurement timing associated with the first CLI measurement and the second CLI measurement may be based at least in part on an uplink timing, or the measurement timing may be indicated in a report configuration as an offset from the uplink timing.

In some aspects, the first CLI measurement resource may be a CLI-SINR measurement resource that corresponds to the reference signal, where the reference signal may be received from the network node in the first subband. The reference signal may be the CSI-RS. The first subband may be the downlink subband. The second CLI measurement resource may be a CLI-RSSI measurement resource configured in the second subband. The second subband may be the uplink subband. A measurement timing associated with the first CLI measurement and the second CLI measurement may be based at least in part on a downlink timing.

In some aspects, the first CLI measurement resource may be a CLI-SINR measurement resource that corresponds to the reference signal, where the reference signal may be a first reference signal received from the network node in the first subband. The first reference signal may be the CSI-RS. The first subband may be the downlink subband. The second CLI measurement resource may be a CLI-RSRP measurement resource that corresponds to the reference signal, where the reference signal may be a second reference signal received from the second UE in the second subband. The second reference signal may be a CLI-RS. The second subband may be the uplink subband. The first CLI measurement resource and the second CLI measurement resource may be based at least in part on a first UE capability of a simultaneous reception and CLI measurement. In some aspects, a measurement timing associated with the first CLI measurement resource may be based at least in part on a first subband timing, and a measurement timing associated with the second CLI measurement resource may be based at least in part on a second subband timing. For example, a measurement timing associated with a CLI-SINR measurement may be based at least in part on a downlink timing, and a measurement timing associated with a CLI-RSRP measurement may be based at least in part on an uplink timing. In some aspects, the CLI-RS and the CSI-RS may be associated with a same symbol in the SBFD slot. Alternatively, the CLI-RS and the CSI-RS may be associated with different periodicities, different symbols, and/or different slots.

In some aspects, the first UE may transmit the CLI report that indicates the first CLI measurement and the second CLI measurement based at least in part on a periodic L3 CLI reporting, a semi-persistent or periodic L2 CLI reporting, or an aperiodic, semi-persistent, or periodic L1 CLI reporting. In some aspects, the CLI report may be a one-part CLI report that indicates the first CLI measurement and the second CLI measurement. The CLI report may be associated with a fixed payload. A maximum quantity of CLI measurements to be reported may be fixed. In some aspects, the CLI report may be a two-part CLI report that includes a first part and a second part. The first part may be associated with the first CLI measurement and the second part may be associated with the second CLI measurement, or both the first CLI measurement and the second CLI measurement may be associated with one of the first part or the second part.

As indicated above, FIG. 9 is provided as an example. Other examples may differ from what is described with regard to FIG. 9.

In some aspects, CLI metrics may be based at least in part on two scenarios. In a first scenario, CLI measurement(s) may be based at least in part on a CLI-RS (e.g., an SRS) in an uplink subband of an SBFD slot. A first UE (e.g., a victim UE) may measure an SRS-RSRP in the uplink subband and a CLI-RSSI in a downlink subband of the SBFD slot. The uplink subband and the downlink subband may be associated with the same SBFD slot. In a second scenario, CLI measurement(s) may be based at least in part on a CSI-RS in a downlink subband. The first UE may measure a CSI-RS SINR (CSI-RS-SINR) in the downlink subband and a CLI-RSSI in an uplink subband. The uplink subband and the downlink subband may be associated with the same SBFD slot.

In some aspects, two CLI measurement resources may be configured for the first UE. The two CLI measurement resources may be associated with two different CLI components. A first CLI measurement resource, of the two CLI measurement resources, may be associated with the uplink subband of the SBFD slot. The first CLI measurement resource may be associated with a first CLI component of the two different CLI components. A second CLI measurement resource, of the two CLI measurement resources, may be associated with the downlink subband of the SBFD slot. The second CLI measurement resource may be associated with a second CLI component of the two different CLI components.

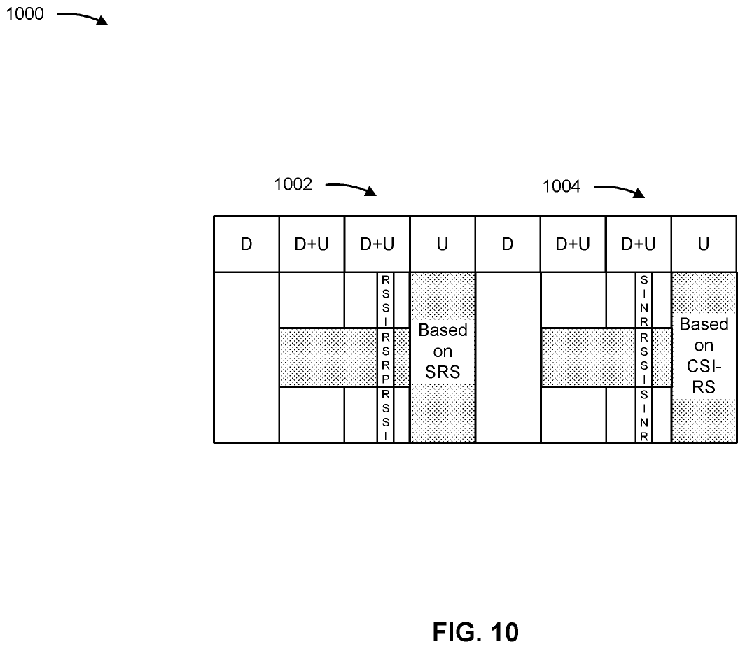

FIG. 10 is a diagram illustrating an example 1000 associated with CLI reporting with measurements for multiple subbands, in accordance with the present disclosure.

As shown in FIG. 10, a first SBFD slot 1002 may be associated with a first downlink subband, an uplink subband, and a third downlink subband. A UE (e.g., a victim UE) may measure an SRS-RSRP in the uplink subband. The UE may measure a CLI-RSSI in each of the first downlink subband and the second downlink subband. In this case, CLI measurement(s) may be based at least in part on a CLI-RS (e.g., an SRS) in the uplink subband. A second SBFD slot 1004 may be associated with a first downlink subband, an uplink subband, and a third downlink subband. A UE (e.g., a victim UE) may measure a CLI-RSSI in the uplink subband. The UE may measure a CSI-RS-SINR in each of the first downlink subband and the second downlink subband. In this case, CLI measurement(s) may be based at least in part on CSI-RS s in downlink subbands.

As indicated above, FIG. 10 is provided as an example. Other examples may differ from what is described with regard to FIG. 10.

In some aspects, a first CLI measurement resource may be a CLI-RSRP measurement resource. The CLI-RSRP measurement resource may correspond to (or match with) a CLI-RS transmitted by a second UE (e.g., an aggressor UE) in an uplink subband of an SBFD slot. For example, the second UE may be configured with an SRS in the uplink subband, and a first UE (e.g., a victim UE) may be configured with the CLI-RSRP measurement resource for measuring a CLI-RSRP associated with the SRS transmitted by the second UE. In some aspects, a second CLI measurement resource may be CLI RSSI measurement resource(s) configured in downlink subband(s) of the SBFD slot. One CLI-RSSI measurement resource may cover each downlink subband. Alternatively, each downlink subband may be divided into multiple subbands, each of which may be covered with a CLI-RSSI measurement resource.

In some aspects, for a measurement timing, the first UE may use an uplink timing for CLI measurements (e.g., CLI-RSRP measurements and CLI-RSSI measurements). In some aspects, a network node may indicate the measurement timing in a report configuration as an offset from the uplink timing. In some aspects, the first UE may transmit, to the network report, a CLI report. The CLI report may indicate CLI measurements based at least in part on the CLI-RSRP measurement resource and the CLI-RSSI measurement resource. The CLI-RSRP measurement resource may be associated with the first CLI component and the CLI-RSSI measurement resource may be associated with the second CLI component.

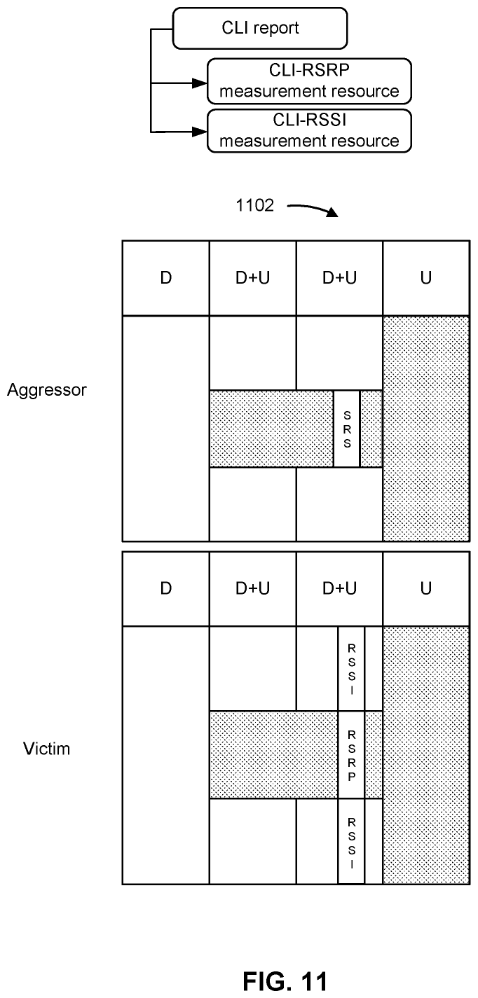

FIG. 11 is a diagram illustrating an example 1100 associated with CLI reporting with measurements for multiple subbands, in accordance with the present disclosure.

As shown in FIG. 11, a second UE (e.g., an aggressor UE) may transmit a CLI-RS (e.g., an SRS) in an uplink subband of an SBFD slot 1102. A first UE (e.g., a victim UE) may perform a CLI-RSRP measurement in the uplink subband of the SBFD slot 1102. The first UE may perform the CLI-RSRP measurement using a first CLI measurement resource (e.g., a CLI-RSRP measurement resource). The first UE may perform CLI-RSSI measurement(s) in downlink subband(s) of the SBFD slot 1102. The first UE may perform the CLI-RSSI measurement(s) using a second CLI measurement resource (e.g., a CLI-RSRP measurement resource). In some aspects, the first UE may transmit, to a network node, a CLI report. The CLI report may indicate CLI measurements associated with the CLI-RSRP measurement resource and the CLI-RSSI measurement resource.

As indicated above, FIG. 11 is provided as an example. Other examples may differ from what is described with regard to FIG. 11.

In some aspects, a first CLI measurement resource may be a CLI-SINR measurement resource. The CLI-SINR measurement resource may correspond to (or match with) a CSI-RS transmitted by a network node in downlink subband(s) of an SBFD slot. A first UE (e.g., a victim UE) may measure a CLI-SINR using the CLI-SINR measurement resource, where a CLI-SINR measurement may be based at least in part on the CSI-RS transmitted by the network node in the downlink subband(s). The CLI-SINR measurement may capture an impact of a CLI leakage and other interference sources. A quantity of CLI-SINR measurement resources may be based at least in part on a quantity of configured CSI-RS resources (e.g., the quantity of CLI-SINR measurement resources may equal the quantity of configured CSI-RS resources). In some aspects, a second CLI measurement resource may be CLI-RSSI measurement resource(s) configured in the uplink subband of the SBFD slot. One CLI-RSSI measurement resource may cover each uplink subband.

In some aspects, for a measurement timing, the first UE may use a downlink timing for measurements. In some aspects, the first UE may transmit, to the network report, a CLI report. The CLI report may indicate CLI measurements based at least in part on the CLI-SINR measurement resource and the CLI-RSSI measurement resource. The CLI-SINR measurement resource may be associated with the first CLI component and the CLI-RSSI measurement resource may be associated with the second CLI component.

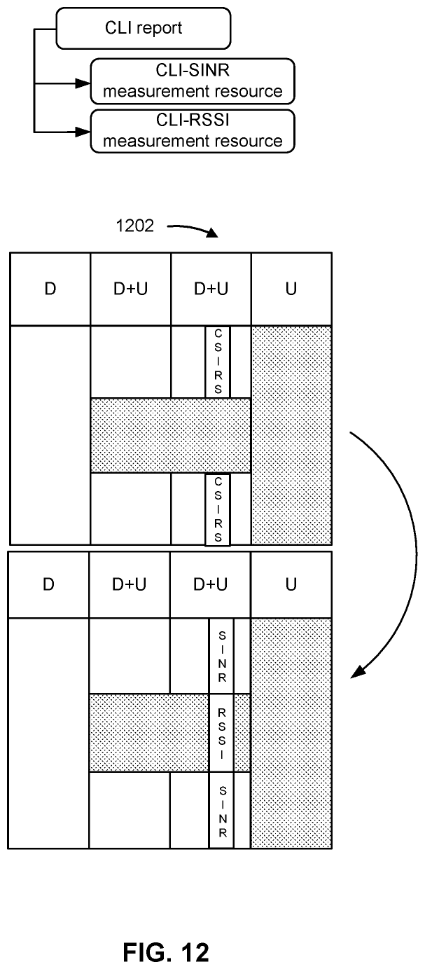

FIG. 12 is a diagram illustrating an example 1200 associated with CLI reporting with measurements for multiple subbands, in accordance with the present disclosure.

As shown in FIG. 12, a network node may transmit CSI-RS(s) in downlink subband(s) of an SBFD slot 1202. A first UE (e.g., a victim UE) may perform CLI-SINR measurement(s) in the downlink subband(s) of the SBFD slot 1202. The first UE may perform the CLI-SINR measurement(s) using a first CLI measurement resource (e.g., a CLI-SINR measurement resource). The first UE may perform CLI-RSSI measurements in an uplink subband of the SBFD slot 1202. The first UE may perform the CLI-RSSI measurement using a second CLI measurement resource (e.g., a CLI-RSSI measurement resource). In some aspects, the first UE may transmit, to a network node, a CLI report. The CLI report may indicate CLI measurements associated with the CLI-SINR measurement resource and the CLI-RSSI measurement resource.

As indicated above, FIG. 12 is provided as an example. Other examples may differ from what is described with regard to FIG. 12.

In some aspects, a first CLI measurement resource may be a CLI-SINR measurement resource and a second CLI measurement resource may be a CLI-RSRP measurement resource, depending on a first UE capability for simultaneous downlink reception and CLI measurement. The CLI-SINR measurement resource may correspond to (or match with) a CSI-RS transmitted by a network node in downlink subband(s) of an SBFD slot. A first UE (e.g., a victim UE) may measure a CLI-SINR using the CLI-SINR measurement resource, where a CLI-SINR measurement may be based at least in part on the CSI-RS transmitted by a network node. The CLI-RSRP measurement resource may correspond to (or match with) a CLI-RS (e.g., an SRS) transmitted by the second UE in the uplink subband of the SBFD slot. The first UE may measure a CLI-RSRP using the CLI-RSRP measurement resource, where a CLI-RSRP measurement may be based at least in part on the CLI-RS transmitted by a second UE (e.g., an aggressor UE).

In some aspects, for a measurement timing, the first UE may use a downlink timing for CLI-SINR measurements. The first UE may use an uplink timing (or a configured timing) for the CLI-RSRP measurement. The CLI-RS and the CSI-RS may be configured to be on the same symbol. Alternatively, the CLI-RS and the CSI-RS may be associated with a different periodicity. For example, the first UE may measure an SRS-RSRP at one occasion, and the UE may measure a CSI-RS-SINR at another occasion, and the UE may report the SRS-RSRP and the CSI-RS-SINR in the same CLI report. In some aspects, the first UE may transmit, to the network report, the CLI report. The CLI report may indicate CLI measurements based at least in part on the CLI-SINR measurement resource and the CLI-RSRP measurement resource. The CLI-SINR measurement resource may be associated with the first CLI component and the CLI-RSRP measurement resource may be associated with the second CLI component.

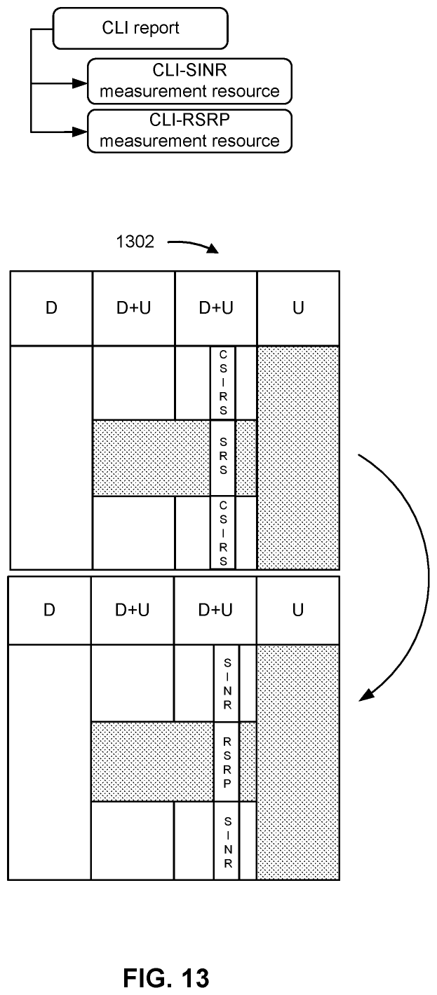

FIG. 13 is a diagram illustrating an example 1300 associated with CLI reporting with measurements for multiple subbands, in accordance with the present disclosure.

As shown in FIG. 13, a network node may transmit CSI-RS(s) in downlink subband(s) of an SBFD slot 1302. A first UE (e.g., a victim UE) may perform CLI-SINR measurement(s) in the downlink subband(s) of the SBFD slot 1302. The first UE may perform the CLI-SINR measurement(s) using a first CLI measurement resource (e.g., a CLI-SINR measurement resource). A second UE (e.g., an aggressor UE) may transmit a CLI-RS (e.g., an SRS) in an uplink subband of the SBFD slot 1302. The first UE may perform a CLI-RSRP measurement in the uplink subband of the SBFD slot 1302. The first UE may perform the CLI-RSRP measurement using a second CLI measurement resource (e.g., a CLI-RSRP measurement resource). In some aspects, the first UE may transmit, to a network node, a CLI report. The CLI report may indicate CLI measurements associated with the CLI-SINR measurement resource and the CLI-RSRP measurement resource.

As indicated above, FIG. 13 is provided as an example. Other examples may differ from what is described with regard to FIG. 13.

In some aspects, a first UE (e.g., a victim UE) may perform a CLI reporting, during which the first UE may report CLI to a network node. In some aspects, the first UE may perform a periodic L3 CLI reporting. The periodic L3 CLI reporting may support reporting two linked resources with different CLI metrics. In some aspects, the first UE may perform a semi-persistent or periodic CLI reporting. The first UE may report CLI in an uplink MAC-CE. The uplink MAC-CE for L2 reporting may include multiple (different) CLI metrics per report. In some aspects, the first UE may perform an aperiodic, semi-persistent or periodic L1 CLI reporting. The first UE may report CLI as uplink control information (UCI) via a PUSCH or PUCCH. A two-metric CLI report may be designed as a one-part report, or alternatively, the two-metric CLI report may be designed as a two-part report.

In some aspects, a CLI report payload and priority may be defined. When the CLI report is associated with multiple CLI measurement resources (e.g., multiple CLI-RSRP/SINR measurement resources), and the first UE selects which CLI-RSRP/SINR measurements to report based at least in part on a certain criterion (e.g., an amount of CLI exceeds a threshold), then the first UE may indicate which CLI-RSRP/SINR measurement resource, of the multiple CLI-RSRP/SINR measurement resources, is reported in the CLI report. In other words, the CLI report may include an indication that indicates which CLI-RSRP/SINR measurement resource is being reported when the multiple CLI-RSRP/SINR measurement resources are available. In some aspects, when all of the multiple CLI-RSRP/SINR measurement resources are to be included in the CLI report, then no indication of CLI-RSRP/SINR measurement resources may be included in the CLI report.

In some aspects, the CLI report may be based at least in part on a one-part report design, in which case the CLI report may be associated with a fixed payload. In some aspects, in the CLI report, an RSRP measurement (or metric) may be followed by an RSSI measurement (or metric). The RSSI measurement may be associated with one or more subbands. For example, the CLI report may include one RSRP measurement and up to four RSSI measurements. In some aspects, in the CLI report, an SINR measurement may be associated with one or more subbands. The SINR measurement may be followed by an RSSI measurement. A maximum quantity of CLI measurements to be reported may be fixed, in which case a payload size may be fixed and a zero filling may be used when a certain field is absent.

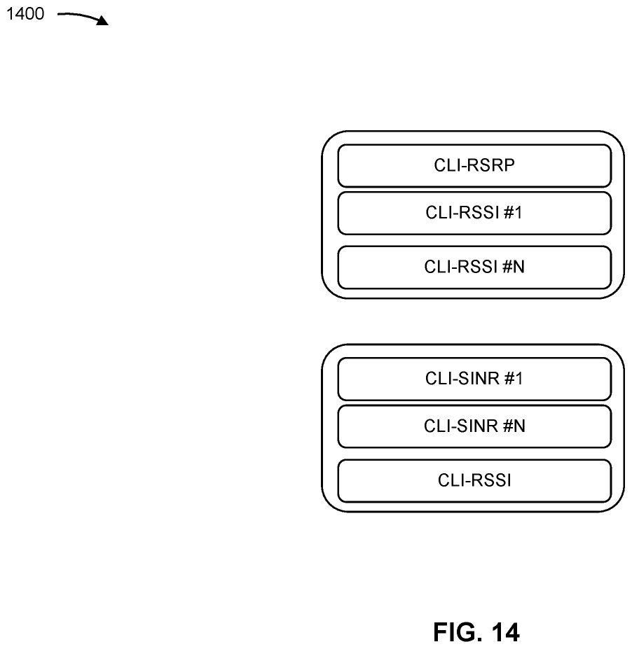

FIG. 14 is a diagram illustrating an example 1400 associated with CLI reporting with measurements for multiple subbands, in accordance with the present disclosure.

As shown in FIG. 14, a CLI report may be based at least in part on a one-part report design, and may be associated with a fixed payload. The CLI report may indicate a CLI-RSRP measurement, which may be followed by CLI-RSSI measurements for one or more subbands (e.g., CLI-RSSI #1 to CLI-RSSI #N). The CLI-RSRP measurement may be associated with a CLI-RS (e.g., an SRS). Additionally, or alternatively, the CLI report may indicate CLI-SINR measurements for one or more subbands (e.g., CLI-SINR #1 to CLI-SINR #N), which may be followed by a CLI-RSSI measurement. The CLI-SINR measurements may be associated with CSI-RSs.

As indicated above, FIG. 14 is provided as an example. Other examples may differ from what is described with regard to FIG. 14.

In some aspects, a CLI report may be based at least in part on a two-part report design, in which case a first part may be associated with a fixed payload and a second part may be associated with a variable payload. In some aspects, CLI-RSRP measurement(s) (e.g., SRS-RSRP measurement(s)) may be associated with the first part and CLI-RSSI measurement(s) may be associated with the second part, or CLI-SINR measurement(s) (e.g., CSI-RS-SINR measurement(s)) may be associated with the first part and CLI-RSSI measurement(s) may be associated with the second part. SRS-RSRP measurements and CSI-RS-SINR measurements may have a higher priority as compared with RSSI measurements. The RSSI measurements may be ordered according to their respective priority. Different priorities may exist over RSSI subband(s). For example, RSSI subbands closer to an uplink subband may be associated with a higher priority as compared to RSSI subbands that are not as close to the uplink subband. In some aspects, CLI measurements may be ordered by CLI-RSRP measurements (and corresponding CLI-RSRP measurement resources). The CLI report, in the first part, may indicate a first CLI-RSRP measurement and associated CLI-RSSI measurement(s). The CLI report, in the second part, may indicate a second CLI-RSRP measurement and associated CLI-RSSI measurement(s). The CLI report may follow a predefined order, which may be based at least in part on a resource identifier.

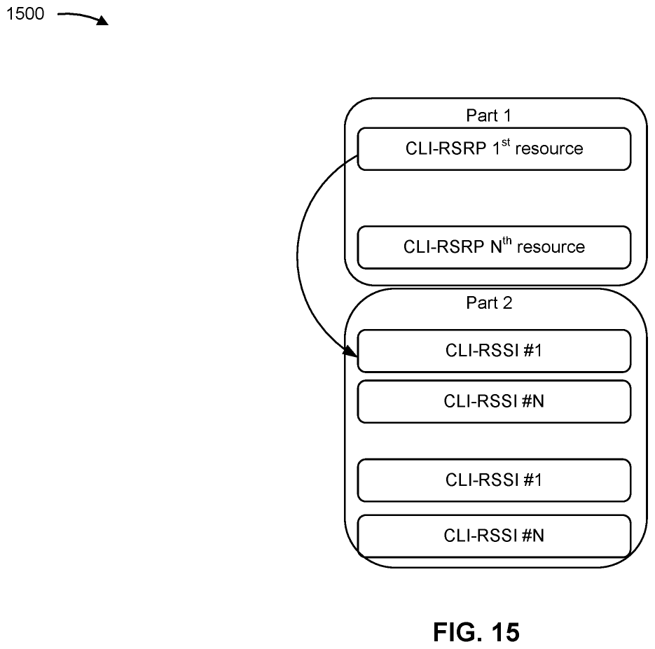

FIG. 15 is a diagram illustrating an example 1500 associated with CLI reporting with measurements for multiple subbands, in accordance with the present disclosure.

As shown in FIG. 15, a CLI report may be based at least in part on a two-part report design, in which case a second part of the CLI report may be associated with a variable payload. A first part of the CLI report may indicate CLI-RSRP measurements associated with CLI-RSRP measurement resources (e.g., CLI-RSRP 1^{st} resource to CLI-RSRP N^{th} resource). The second part of the CLI report may indicate, for the CLI-RSRP 1^{st} resource, CLI-RSSI measurements (e.g., CLI-RSSI #1 to CLI-RSSI #N). The second part of the CLI report may indicate, for the CLI-RSRP N^{th} resource, CLI-RSSI measurements (e.g., CLI-RSSI #1 to CLI-RSSI #N). The second part may be associated with the variable payload.

As indicated above, FIG. 15 is provided as an example. Other examples may differ from what is described with regard to FIG. 15.

In some aspects, in order to reduce a CLI reporting overhead, an uplink CLI component (e.g., a CLI-RSRP measurement or a CLI-RSSI measurement) may be simplified in a CLI report. The CLI report may indicate one or two bits to indicate whether or not a blocking exists. In other words, the CLI report may indicate whether a first UE (e.g., a victim UE) is associated with the blocking. The first UE may determine whether or not the blocking exists by comparing a CLI measurement (e.g., a CLI-RSRP measurement or a CLI-RSSI measurement) and a maximum input power. The blocking may be based at least in part on a comparison of the CLI measurement to the maximum input power. For example, when a difference between the measurement and the maximum input power satisfies a threshold, the first UE may determine that the blocking exists, and the first UE may transmit an indication that the blocking exists to a network node, as opposed to sending the actual measurements.

FIG. 16 is a diagram illustrating an example process 1600 performed, for example, by a first UE, in accordance with the present disclosure. Example process 1600 is an example where the first UE (e.g., UE 120a) performs operations associated with CLI reporting with measurements for multiple subbands.

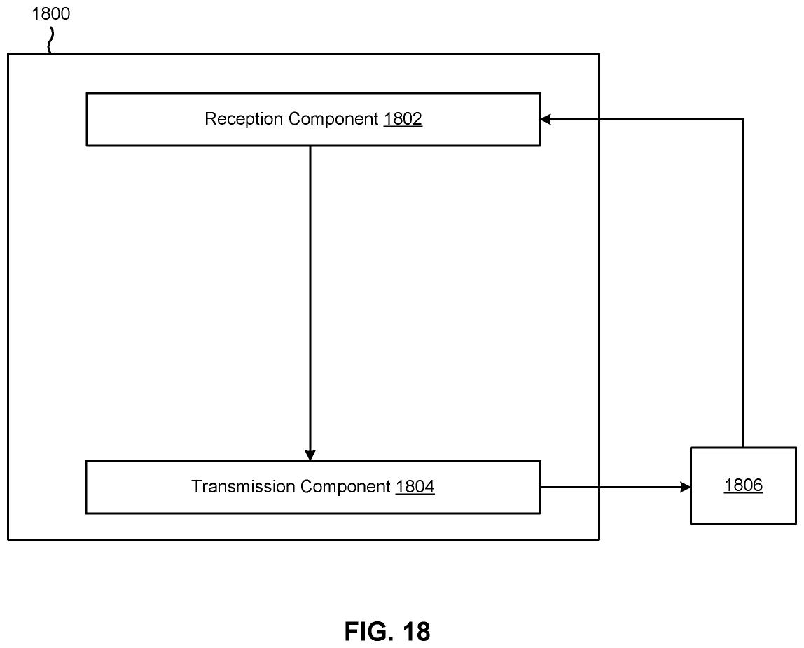

As shown in FIG. 16, in some aspects, process 1600 may include receiving, from one or more of a network node or a second UE, a reference signal in a first subband of an SBFD slot (block 1610). For example, the first UE (e.g., using reception component 1802, depicted in FIG. 18) may receive, from one or more of a network node or a second UE, a reference signal in a first subband of an SBFD slot, as described above.

As further shown in FIG. 16, in some aspects, process 1600 may include transmitting, to the network node, a CLI report that indicates: a first CLI measurement associated with the reference signal in the first subband of the SBFD slot, and a second CLI measurement associated with a second subband of the SBFD slot (block 1620). For example, the first UE (e.g., using transmission component 1804, depicted in FIG. 18) may transmit, to the network node, a CLI report that indicates: a first CLI measurement associated with the reference signal in the first subband of the SBFD slot, and a second CLI measurement associated with a second subband of the SBFD slot, as described above.

Process 1600 may include additional aspects, such as any single aspect or any combination of aspects described below and/or in connection with one or more other processes described elsewhere herein.

In a first aspect, the CLI report is associated with a first CLI component and a second CLI component, wherein the first CLI component is associated with the first CLI measurement for the first subband, wherein the second CLI component is associated with the second CLI component for the second subband, and the first subband and the second subband are associated with different types of subbands.

In a second aspect, alone or in combination with the first aspect, the reference signal is a CLI-RS received from the second UE, and the CLI-RS is an SRS, the first subband is an uplink subband and the second subband is a downlink subband, the first CLI measurement is associated with a CLI-RS RSRP in the uplink subband, and the second CLI measurement is associated with a CLI RSSI in the downlink subband.

In a third aspect, alone or in combination with one or more of the first and second aspects, the reference signal is a CSI-RS received from the network node, the first subband is a downlink subband and the second subband is an uplink subband, the first CLI measurement is associated with a CSI-RS-SINR in the downlink subband, and the second CLI measurement is associated with a CLI RSSI in the uplink subband.

In a fourth aspect, alone or in combination with one or more of the first through third aspects, process 1600 includes receiving, from the network node, a configuration that indicates a first CLI measurement resource and a second CLI measurement resource, wherein the first CLI measurement is associated with the first CLI measurement resource and the second CLI measurement is associated with the second CLI measurement resource.

In a fifth aspect, alone or in combination with one or more of the first through fourth aspects, the first CLI measurement resource is a CLI-RSRP measurement resource that corresponds to the reference signal, the reference signal is received from the second UE in the first subband, the reference signal is a CLI-RS, and the first subband is an uplink subband, the second CLI measurement resource is a CLI-RSSI measurement resource configured in the second subband, and the second subband is a downlink subband, and a measurement timing associated with the first CLI measurement and the second CLI measurement is based at least in part on an uplink timing, or the measurement timing is indicated in a report configuration as an offset from the uplink timing.

In a sixth aspect, alone or in combination with one or more of the first through fifth aspects, the first CLI measurement resource is a CLI-SINR measurement resource that corresponds to the reference signal, the reference signal is received from the network node in the first subband, the reference signal is a CSI-RS, and the first subband is a downlink subband, the second CLI measurement resource is a CLI-RSSI measurement resource configured in the second subband, and the second subband is an uplink subband, and a measurement timing associated with the first CLI measurement and the second CLI measurement is based at least in part on a downlink timing.

In a seventh aspect, alone or in combination with one or more of the first through sixth aspects, the first CLI measurement resource is a CLI-SINR measurement resource that corresponds to the reference signal, the reference signal is a first reference signal received from the network node in the first subband, the first reference signal is a CSI-RS, and the first subband is a downlink subband, the second CLI measurement resource is a CLI-RSRP measurement resource that corresponds to the reference signal, the reference signal is a second reference signal received from the second UE in the second subband, the second reference signal is a CLI-RS, and the second subband is an uplink subband, and the first CLI measurement resource and the second CLI measurement resource are based at least in part on a first UE capability of a simultaneous reception and CLI measurement.

In an eighth aspect, alone or in combination with one or more of the first through seventh aspects, a measurement timing associated with the first CLI measurement resource is based at least in part on a first subband timing, and a measurement timing associated with the second CLI measurement resource is based at least in part on a second subband timing.

In a ninth aspect, alone or in combination with one or more of the first through eighth aspects, the CLI-RS and the CSI-RS are associated with a same symbol in the SBFD slot, or the CLI-RS and the CSI-RS are associated with one or more of different periodicities, different symbols, or different slots.

In a tenth aspect, alone or in combination with one or more of the first through ninth aspects, process 1600 includes transmitting the CLI report that indicates the first CLI measurement and the second CLI measurement based at least in part on one of a periodic L3 CLI reporting, a semi-persistent or periodic L2 CLI reporting, or an aperiodic, semi-persistent, or periodic L1 CLI reporting.

In an eleventh aspect, alone or in combination with one or more of the first through tenth aspects, the CLI report is associated with multiple CLI measurement resources, and the CLI report indicates a CLI measurement resource, of the multiple CLI measurement resources, that is associated with the CLI report, or the CLI report indicates whether the first UE is associated with a blocking, and the blocking is based at least in part on a comparison of one or more of the first CLI measurement or the second CLI measurement, to a maximum input power.

In a twelfth aspect, alone or in combination with one or more of the first through eleventh aspects, the CLI report is a one-part CLI report that indicates the first CLI measurement and the second CLI measurement, the CLI report is associated with a fixed payload, and a maximum quantity of CLI measurements to be reported is fixed.

In a thirteenth aspect, alone or in combination with one or more of the first through twelfth aspects, the CLI report is a two-part CLI report that includes a first part and a second part, and the first part is associated with the first CLI measurement and the second part is associated with the second CLI measurement, or both the first CLI measurement and the second CLI measurement are associated with one of the first part or the second part.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network node, in accordance with the present disclosure. Example process 1700 is an example where the network node (e.g., network node 110) performs operations associated with CLI reporting with measurements for multiple subbands.

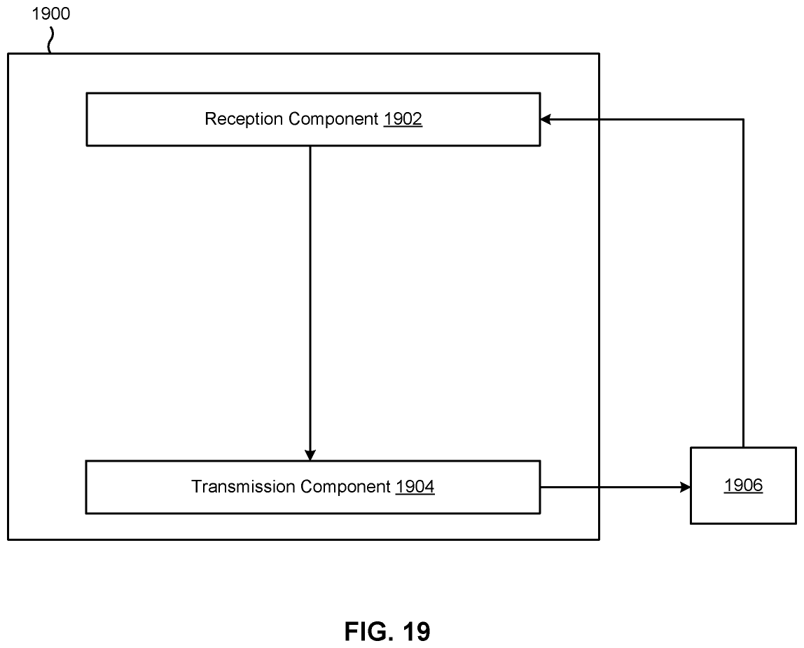

As shown in FIG. 17, in some aspects, process 1700 may include transmitting, to a UE, a configuration that indicates a first CLI measurement resource and a second CLI measurement resource (block 1710). For example, the network node (e.g., using transmission component 1904, depicted in FIG. 19) may transmit, to a UE, a configuration that indicates a first CLI measurement resource and a second CLI measurement resource, as described above.

As further shown in FIG. 17, in some aspects, process 1700 may include receiving, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot (block 1720). For example, the network node (e.g., using reception component 1902, depicted in FIG. 19) may receive, from the UE and based at least in part on the configuration, a CLI report that indicates: a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot, as described above.

Process 1700 may include additional aspects, such as any single aspect or any combination of aspects described below and/or in connection with one or more other processes described elsewhere herein.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a first UE, or a first UE may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804.

In some aspects, the apparatus 1800 may be configured to perform one or more operations described herein in connection with FIGS. 9-15. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the first UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the first UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the first UE described in connection with FIG. 2. In some aspects, the transmission component 1804 may be co-located with the reception component 1802 in a transceiver.

The reception component 1802 may receive, from one or more of a network node or a second UE, a reference signal in a first subband of an SBFD slot. The transmission component 1804 may transmit, to the network node, a CLI report that indicates a first CLI measurement associated with the reference signal in the first subband of the SBFD slot, and a second CLI measurement associated with a second subband of the SBFD slot. The reception component 1802 may receive, from the network node, a configuration that indicates a first CLI measurement resource and a second CLI measurement resource, wherein the first CLI measurement is associated with the first CLI measurement resource and the second CLI measurement is associated with the second CLI measurement resource.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a network node, or a network node may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a base station, or another wireless communication device) using the reception component 1902 and the transmission component 1904.

In some aspects, the apparatus 1900 may be configured to perform one or more operations described herein in connection with FIGS. 9-15. Additionally, or alternatively, the apparatus 1900 may be configured to perform one or more processes described herein, such as process 1700 of FIG. 17. In some aspects, the apparatus 1900 and/or one or more components shown in FIG. 19 may include one or more components of the network node described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network node described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the network node described in connection with FIG. 2. In some aspects, the transmission component 1904 may be co-located with the reception component 1902 in a transceiver.

The transmission component 1904 may transmit, to a UE, a configuration that indicates a first CLI measurement resource and a second CLI measurement resource. The reception component 1902 may receive, from the UE and based at least in part on the configuration, a CLI report that indicates a first CLI measurement associated with the first CLI measurement resource, wherein the first CLI measurement is associated with a reference signal in a first subband of an SBFD slot, and a second CLI measurement associated with the second CLI measurement resource, wherein the second CLI measurement is associated with a second subband of the SBFD slot.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:
Aspect 1: A method of wireless communication performed by an apparatus of a first user equipment (UE), comprising: receiving, from one or more of a network node or a second UE, a reference signal in a first subband of a sub-band full-duplex (SBFD) slot; and transmitting, to the network node, a cross-link interference (CLI) report that indicates: a first CLI measurement associated with the reference signal in the first subband of the SBFD slot, and a second CLI measurement associated with a second subband of the SBFD slot.
Aspect 2: The method of Aspect 1, wherein the CLI report is associated with a first CLI component and a second CLI component, wherein the first CLI component is associated with the first CLI measurement for the first subband, wherein the second CLI component is associated with the second CLI component for the second subband, and wherein the first subband and the second subband are associated with different types of subbands.
Aspect 3: The method of any of Aspects 1 through 2, wherein: the reference signal is a CLI reference signal (CLI-RS) received from the second UE, and the CLI-RS is a sounding reference signal, the first subband is an uplink subband and the second subband is a downlink subband, the first CLI measurement is associated with a CLI-RS reference signal received power in the uplink subband, and the second CLI measurement is associated with a CLI received signal strength indicator in the downlink subband.
Aspect 4: The method of any of Aspects 1 through 3, wherein: the reference signal is a channel state information reference signal (CSI-RS) received from the network node, the first subband is a downlink subband and the second subband is an uplink subband, the first CLI measurement is associated with a CSI-RS signal-to-interference-plus-noise ratio in the downlink subband; and the second CLI measurement is associated with a CLI received signal strength indicator in the uplink subband.
Aspect 5: The method of any of Aspects 1 through 4, further comprising: receiving, from the network node, a configuration that indicates a first CLI measurement resource and a second CLI measurement resource, wherein the first CLI measurement is associated with the first CLI measurement resource and the second CLI measurement is associated with the second CLI measurement resource.
Aspect 6: The method of Aspect 5, wherein: the first CLI measurement resource is a CLI reference signal received power measurement resource that corresponds to the reference signal, the reference signal is received from the second UE in the first subband, the reference signal is a CLI reference signal, and the first subband is an uplink subband; the second CLI measurement resource is a CLI received signal strength indicator measurement resource configured in the second subband, and the second subband is a downlink subband; and a measurement timing associated with the first CLI measurement and the second CLI measurement is based at least in part on an uplink timing, or the measurement timing is indicated in a report configuration as an offset from the uplink timing.
Aspect 7: The method of Aspect 5, wherein: the first CLI measurement resource is a CLI signal-to-interference-plus-noise ratio measurement resource that corresponds to the reference signal, the reference signal is received from the network node in the first subband, the reference signal is a channel state information reference signal, and the first subband is a downlink subband; the second CLI measurement resource is a CLI received signal strength indicator measurement resource configured in the second subband, and the second subband is an uplink subband; and a measurement timing associated with the first CLI measurement and the second CLI measurement is based at least in part on a downlink timing.
Aspect 8: The method of Aspect 5, wherein: the first CLI measurement resource is a CLI signal-to-interference-plus-noise ratio measurement resource that corresponds to the reference signal, the reference signal is a first reference signal received from the network node in the first subband, the first reference signal is a channel state information reference signal (CSI-RS), and the first subband is a downlink subband; the second CLI measurement resource is a CLI reference signal received power measurement resource that corresponds to the reference signal, the reference signal is a second reference signal received from the second UE in the second subband, the second reference signal is a CLI reference signal (CLI-RS), and the second subband is an uplink subband; and the first CLI measurement resource and the second CLI measurement resource are based at least in part on a first UE capability of a simultaneous reception and CLI measurement.
Aspect 9: The method of Aspect 8, wherein: a measurement timing associated with the first CLI measurement resource is based at least in part on a first subband timing; and a measurement timing associated with the second CLI measurement resource is based at least in part on a second subband timing.
Aspect 10: The method of Aspect 8, wherein: the CLI-RS and the CSI-RS are associated with a same symbol in the SBFD slot; or the CLI-RS and the CSI-RS are associated with one or more of different periodicities, different symbols, or different slots.
Aspect 11: The method of any of Aspects 1 through 10, wherein transmitting the CLI report that indicates the first CLI measurement and the second CLI measurement is based at least in part on one of: a periodic layer 3 CLI reporting; a semi-persistent or periodic layer 2 CLI reporting; or an aperiodic, semi-persistent, or periodic layer 1 CLI reporting.
Aspect 12: The method of any of Aspects 1 through 11, wherein: the CLI report is associated with multiple CLI measurement resources, and the CLI report indicates a CLI measurement resource, of the multiple CLI measurement resources, that is associated with the CLI report; or the CLI report indicates whether the first UE is associated with a blocking, and the blocking is based at least in part on a comparison of one or more of the first CLI measurement or the second CLI measurement, to a maximum input power.
Aspect 13: The method of any of Aspects 1 through 12, wherein: the CLI report is a one-part CLI report that indicates the first CLI measurement and the second CLI measurement, the CLI report is associated with a fixed payload, and a maximum quantity of CLI measurements to be reported is fixed.
Aspect 14: The method of any of Aspects 1 through 13, wherein: the CLI report is a two-part CLI report that includes a first part and a second part, and the first part is associated with the first CLI measurement and the second part is associated with the second CLI measurement, or both the first CLI measurement and the second CLI measurement are associated with one of the first part or the second part.
Aspect 15: A method of wireless communication performed by an apparatus of a network node, comprising: transmitting, to a user equipment (UE), a configuration that indicates a first cross-link interference (CLI) measurement resource and a second CLI measurement resource; and receiving, from the UE and based at least in part on the configuration, a CLI report that indicates: a first CLI measurement associated with the first CLI measurement resource, wherein the first CLI measurement is associated with a reference signal in a first subband of a sub-band full-duplex (SBFD) slot, and a second CLI measurement associated with the second CLI measurement resource, wherein the second CLI measurement is associated with a second subband of the SBFD slot.
Aspect 16: An apparatus for wireless communication at a device, comprising a processor; memory coupled with the processor; and instructions stored in the memory and executable by the processor to cause the apparatus to perform the method of one or more of Aspects 1-14.
Aspect 17: A device for wireless communication, comprising a memory and one or more processors coupled to the memory, the one or more processors configured to perform the method of one or more of Aspects 1-14.
Aspect 18: An apparatus for wireless communication, comprising at least one means for performing the method of one or more of Aspects 1-14.
Aspect 19: A non-transitory computer-readable medium storing code for wireless communication, the code comprising instructions executable by a processor to perform the method of one or more of Aspects 1-14.
Aspect 20: A non-transitory computer-readable medium storing a set of instructions for wireless communication, the set of instructions comprising one or more instructions that, when executed by one or more processors of a device, cause the device to perform the method of one or more of Aspects 1-14.
Aspect 21: An apparatus for wireless communication at a device, comprising a processor; memory coupled with the processor; and instructions stored in the memory and executable by the processor to cause the apparatus to perform the method of Aspect 15.
Aspect 22: A device for wireless communication, comprising a memory and one or more processors coupled to the memory, the one or more processors configured to perform the method of Aspect 15.
Aspect 23: An apparatus for wireless communication, comprising at least one means for performing the method of Aspect 15.
Aspect 24: A non-transitory computer-readable medium storing code for wireless communication, the code comprising instructions executable by a processor to perform the method of Aspect 15.
Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
one or more memories; and
one or more processors coupled to the one or more memories, the one or more processors individually or collectively configured to:
receive, from one or more of a network node or a second UE, a reference signal in a first subband of a sub-band full-duplex (SBFD) slot; and
transmit, to the network node, a cross-link interference (CLI) report that indicates:
a first CLI measurement associated with the reference signal in the first subband of the SBFD slot, and
a second CLI measurement associated with a second subband of the SBFD slot.

2. The apparatus of claim 1, wherein the CLI report is associated with a first CLI component and a second CLI component, wherein the first CLI component is associated with the first CLI measurement for the first subband, wherein the second CLI component is associated with the second CLI component for the second subband, and wherein the first subband and the second subband are associated with different types of subbands.

3. The apparatus of claim 1, wherein:
the reference signal is a CLI reference signal (CLI-RS) received from the second UE, and the CLI-RS is a sounding reference signal,
the first subband is an uplink subband and the second subband is a downlink subband,
the first CLI measurement is associated with a CLI-RS reference signal received power in the uplink subband, and
the second CLI measurement is associated with a CLI received signal strength indicator in the downlink subband.

4. The apparatus of claim 1, wherein:
the reference signal is a channel state information reference signal (CSI-RS) received from the network node,
the first subband is a downlink subband and the second subband is an uplink subband,
the first CLI measurement is associated with a CSI-RS signal-to-interference-plus-noise ratio in the downlink subband; and
the second CLI measurement is associated with a CLI received signal strength indicator in the uplink subband.

5. The apparatus of claim 1, wherein the one or more processors are further individually or collectively configured to:
receive, from the network node, a configuration that indicates a first CLI measurement resource and a second CLI measurement resource, wherein the first CLI measurement is associated with the first CLI measurement resource and the second CLI measurement is associated with the second CLI measurement resource.

6. The apparatus of claim 5, wherein:
the first CLI measurement resource is a CLI reference signal received power measurement resource that corresponds to the reference signal, the reference signal is received from the second UE in the first subband, the reference signal is a CLI reference signal, and the first subband is an uplink subband;
the second CLI measurement resource is a CLI received signal strength indicator measurement resource configured in the second subband, and the second subband is a downlink subband; and
a measurement timing associated with the first CLI measurement and the second CLI measurement is based at least in part on an uplink timing, or the measurement timing is indicated in a report configuration as an offset from the uplink timing.

7. The apparatus of claim 5, wherein:
the first CLI measurement resource is a CLI signal-to-interference-plus-noise ratio measurement resource that corresponds to the reference signal, the reference signal is received from the network node in the first subband, the reference signal is a channel state information reference signal, and the first subband is a downlink subband;
the second CLI measurement resource is a CLI received signal strength indicator measurement resource configured in the second subband, and the second subband is an uplink subband; and
a measurement timing associated with the first CLI measurement and the second CLI measurement is based at least in part on a downlink timing.

8. The apparatus of claim 5, wherein:
the first CLI measurement resource is a CLI signal-to-interference-plus-noise ratio measurement resource that corresponds to the reference signal, the reference signal is a first reference signal received from the network node in the first subband, the first reference signal is a channel state information reference signal (CSI-RS), and the first subband is a downlink subband;
the second CLI measurement resource is a CLI reference signal received power measurement resource that corresponds to the reference signal, the reference signal is a second reference signal received from the second UE in the second subband, the second reference signal is a CLI reference signal (CLI-RS), and the second subband is an uplink subband; and
the first CLI measurement resource and the second CLI measurement resource are based at least in part on a first UE capability of a simultaneous reception and CLI measurement.

9. The apparatus of claim 8, wherein:
a measurement timing associated with the first CLI measurement resource is based at least in part on a first subband timing; and
a measurement timing associated with the second CLI measurement resource is based at least in part on a second subband timing.

10. The apparatus of claim 8, wherein:
the CLI-RS and the CSI-RS are associated with a same symbol in the SBFD slot; or
the CLI-RS and the CSI-RS are associated with one or more of different periodicities, different symbols, or different slots.

11. The apparatus of claim 1, wherein the one or more processors are individually or collectively configured to transmit the CLI report that indicates the first CLI measurement and the second CLI measurement based at least in part on one of:
a periodic layer 3 CLI reporting;
a semi-persistent or periodic layer 2 CLI reporting; or
an aperiodic, semi-persistent, or periodic layer 1 CLI reporting.

12. The apparatus of claim 1, wherein:
the CLI report is associated with multiple CLI measurement resources, and the CLI report indicates a CLI measurement resource, of the multiple CLI measurement resources, that is associated with the CLI report; or
the CLI report indicates whether the first UE is associated with a blocking, and the blocking is based at least in part on a comparison of one or more of the first CLI measurement or the second CLI measurement, to a maximum input power.

13. The apparatus of claim 1, wherein:
the CLI report is a one-part CLI report that indicates the first CLI measurement and the second CLI measurement,
the CLI report is associated with a fixed payload, and
a maximum quantity of CLI measurements to be reported is fixed.

14. The apparatus of claim 1, wherein:
the CLI report is a two-part CLI report that includes a first part and a second part, and
the first part is associated with the first CLI measurement and the second part is associated with the second CLI measurement, or both the first CLI measurement and the second CLI measurement are associated with one of the first part or the second part.

15. An apparatus for wireless communication at a network node, comprising:
one or more memories; and
one or more processors coupled to the one or more memories, the one or more processors individually or collectively configured to:
transmit, to a user equipment (UE), a configuration that indicates a first cross-link interference (CLI) measurement resource and a second CLI measurement resource; and
receive, from the UE and based at least in part on the configuration, a CLI report that indicates:
a first CLI measurement associated with the first CLI measurement resource, wherein the first CLI measurement is associated with a reference signal in a first subband of a sub-band full-duplex (SBFD) slot, and
a second CLI measurement associated with the second CLI measurement resource, wherein the second CLI measurement is associated with a second subband of the SBFD slot.

16. A method of wireless communication performed by an apparatus of a first user equipment (UE), comprising:
receiving, from one or more of a network node or a second UE, a reference signal in a first subband of a sub-band full-duplex (SBFD) slot; and
transmitting, to the network node, a cross-link interference (CLI) report that indicates:
a first CLI measurement associated with the reference signal in the first subband of the SBFD slot, and
a second CLI measurement associated with a second subband of the SBFD slot.

17. The method of claim 16, wherein the CLI report is associated with a first CLI component and a second CLI component, wherein the first CLI component is associated with the first CLI measurement for the first subband, wherein the second CLI component is associated with the second CLI component for the second subband, and wherein the first subband and the second subband are associated with different types of subbands.

18. The method of claim 16, wherein:
the reference signal is a CLI reference signal (CLI-RS) received from the second UE, and the CLI-RS is a sounding reference signal,
the first subband is an uplink subband and the second subband is a downlink subband,
the first CLI measurement is associated with a CLI-RS reference signal received power in the uplink subband, and
the second CLI measurement is associated with a CLI received signal strength indicator in the downlink subband.

19. The method of claim 16, wherein:
the reference signal is a channel state information reference signal (CSI-RS) received from the network node,
the first subband is a downlink subband and the second subband is an uplink subband,
the first CLI measurement is associated with a CSI-RS signal-to-interference-plus-noise ratio in the downlink subband; and
the second CLI measurement is associated with a CLI received signal strength indicator in the uplink subband.

20. The method of claim 16, further comprising:
receiving, from the network node, a configuration that indicates a first CLI measurement resource and a second CLI measurement resource, wherein the first CLI measurement is associated with the first CLI measurement resource and the second CLI measurement is associated with the second CLI measurement resource.

21. The method of claim 20, wherein:
the first CLI measurement resource is a CLI reference signal received power measurement resource that corresponds to the reference signal, the reference signal is received from the second UE in the first subband, the reference signal is a CLI reference signal, and the first subband is an uplink subband;
the second CLI measurement resource is a CLI received signal strength indicator measurement resource configured in the second subband, and the second subband is a downlink subband; and
a measurement timing associated with the first CLI measurement and the second CLI measurement is based at least in part on an uplink timing, or the measurement timing is indicated in a report configuration as an offset from the uplink timing.

22. The method of claim 20, wherein:
the first CLI measurement resource is a CLI signal-to-interference-plus-noise ratio measurement resource that corresponds to the reference signal, the reference signal is received from the network node in the first subband, the reference signal is a channel state information reference signal, and the first subband is a downlink subband;
the second CLI measurement resource is a CLI received signal strength indicator measurement resource configured in the second subband, and the second subband is an uplink subband; and
a measurement timing associated with the first CLI measurement and the second CLI measurement is based at least in part on a downlink timing.

23. The method of claim 20, wherein:
the first CLI measurement resource is a CLI signal-to-interference-plus-noise ratio measurement resource that corresponds to the reference signal, the reference signal is a first reference signal received from the network node in the first subband, the first reference signal is a channel state information reference signal (CSI-RS), and the first subband is a downlink subband;
the second CLI measurement resource is a CLI reference signal received power measurement resource that corresponds to the reference signal, the reference signal is a second reference signal received from the second UE in the second subband, the second reference signal is a CLI reference signal (CLI-RS), and the second subband is an uplink subband; and
the first CLI measurement resource and the second CLI measurement resource are based at least in part on a first UE capability of a simultaneous reception and CLI measurement.

24. The method of claim 23, wherein:
a measurement timing associated with the first CLI measurement resource is based at least in part on a first subband timing; and
a measurement timing associated with the second CLI measurement resource is based at least in part on a second subband timing.

25. The method of claim 23, wherein:
the CLI-RS and the CSI-RS are associated with a same symbol in the SBFD slot; or
the CLI-RS and the CSI-RS are associated with one or more of different periodicities, different symbols, or different slots.

26. The method of claim 16, wherein transmitting the CLI report that indicates the first CLI measurement and the second CLI measurement is based at least in part on one of:
a periodic layer 3 CLI reporting;
a semi-persistent or periodic layer 2 CLI reporting; or
an aperiodic, semi-persistent, or periodic layer 1 CLI reporting.

27. The method of claim 16, wherein:
the CLI report is associated with multiple CLI measurement resources, and the CLI report indicates a CLI measurement resource, of the multiple CLI measurement resources, that is associated with the CLI report; or
the CLI report indicates whether the first UE is associated with a blocking, and the blocking is based at least in part on a comparison of one or more of the first CLI measurement or the second CLI measurement, to a maximum input power.

28. The method of claim 16, wherein:
the CLI report is a one-part CLI report that indicates the first CLI measurement and the second CLI measurement,
the CLI report is associated with a fixed payload, and
a maximum quantity of CLI measurements to be reported is fixed.

29. The method of claim 16, wherein:
the CLI report is a two-part CLI report that includes a first part and a second part, and
the first part is associated with the first CLI measurement and the second part is associated with the second CLI measurement, or both the first CLI measurement and the second CLI measurement are associated with one of the first part or the second part.

30. A method of wireless communication performed by an apparatus of a network node, comprising:
transmitting, to a user equipment (UE), a configuration that indicates a first cross-link interference (CLI) measurement resource and a second CLI measurement resource; and
receiving, from the UE and based at least in part on the configuration, a CLI report that indicates:
a first CLI measurement associated with the first CLI measurement resource, wherein the first CLI measurement is associated with a reference signal in a first subband of a sub-band full-duplex (SBFD) slot, and
a second CLI measurement associated with the second CLI measurement resource, wherein the second CLI measurement is associated with a second subband of the SBFD slot.
